(19) United States
(12) Patent Application Publication
(10) Pub. No.: US 2012/0182273 A1
(43) Pub. Date: Jul. 19, 2012

(54) DATA PROCESSING DEVICE AND SEMICONDUCTOR DEVICE

(75) Inventors: Shinyu NINOMIYA, Kanagawa (JP); Satoshi UCHINO, Kanagawa (JP)

(73) Assignee: RENESAS ELECTRONICS CORPORATION

(21) Appl. No.: 13/350,145

(22) Filed: Jan. 13, 2012

(30) Foreign Application Priority Data
Jan. 17, 2011 (JP) 2011-006782

(51) Int. Cl. G06F 3/038; G06F 3/00

(52) U.S. Cl. 345/204; 710/36; 345/87

(57) ABSTRACT

Data transfer is enabled according to the reception capability of each of peripherals when a plurality of peripherals is connected to a host device via common lanes.

A data processing device 1 includes a host device 10 provided with an interface, a first device 12 connected to the interface via a plurality of data lanes, and a second device 13 connected to the interface via some of the data lanes. The interface adds dummy data to actual data and then assigns and transmits the resultant data to the data lanes. When the actual data is taken in one of the first device and the second device, the interface causes the other one to recognize that the actual data is meaningless. Therefore, data can be transferred to the first device 12 and the second device 13 in accordance with reception capabilities.

### CROSS-REFERENCE TO RELATED APPLICATION

The disclosure of Japanese Patent Application No. 2011-6782 filed on Jan. 17, 2011 including the specification, drawings and abstract is incorporated herein by reference in its entirety.

### BACKGROUND

The present invention relates to a data transfer technique in differential serial communication.

Japanese Patent Laid-Open No. 2006-330551 (Patent document 1) discloses a technique for reducing the number of dedicated signal wirings connecting a host device with a sub-display liquid crystal driver and a peripheral device. According to Patent document 1, a liquid crystal drive control device can distribute a signal on a circuit which is controlled by a level signal with its logic level determined, like controlling the strobe of the sub-display liquid crystal driver and controlling a peripheral device such as a camera flashlight and an LED (Light Emitting Diode) for illumination display.

Japanese Patent Laid-Open 2008-070715 (Patent document 2) discloses a technique for preventing the increase of the number of output terminals of an interface control signal which controls a parallel interface for sub-liquid-crystal-display control device, in a semiconductor integrated circuit as the liquid crystal drive control device.

### SUMMARY

The mobile industry processor interface (MIPI) is known as an interface standard of a camera and a display in a mobile device. The display serial interface (DSI) of the MIPI connects a device (host device) outputting image data and a device (peripheral) such as a liquid crystal display via a clock lane for transferring a synchronization signal and data lanes for transferring display data and a control signal. Each of the clock lane and the data lanes are differential serial communication paths. While the number of the clock lanes is one, the number of the data lanes depends on a required band width in designing system. The MIPI-DSI can externally connect a plurality of main LCDs and sub-LCDs via virtual channels. This allows to identify each of the LCDs.

Separately providing the host device with an interface dedicated for a main LCD and that for a sub-LCD allows to connect the main LCD (Liquid Crystal Display) and the sub-LCD to the host device by using the numbers of data lanes corresponding to the required band widths.

When the interface dedicated for the main LCD and that for dedicated for the sub-LCD are provided separately, the lanes connected to the interface dedicated for the main LCD and that for the sub-LCD need to be provided separately. This increases manufacturing cost and power consumption.

The sub-LCD has a lower resolution than that of the main LCD. Considering that all the peripherals are to be connected to a common interface, the same number of the data lanes should be used in the configuration. The number of the data lanes depends on the main LCD which requires a higher band width than that of the sub-LCD connected to the host device.

However, the configuration using the same number of the lanes causes the number of the lanes for lane forming on the sub-LCD to be larger than a case that the sub-LCD alone is connected to the host device by the dedicated interface. Furthermore, the sub-LCD needs a capability, which is equivalent to that of the main LCD, of receiving data which has a band width higher than that required for the sub-LCD. This increases the manufacturing cost.

As described in Patent document 1, a configuration which receives a signal from the host device in the liquid crystal drive control device and supplies a drive signal from the device to a circuit for the sub-display needs to mount a circuit for controlling the sub-LCD on the main LCD.

An object of the present invention is to provide a technique for enabling data transfer according to a reception capability of each of a plurality of peripherals when they are connected to a host device via common lanes.

The description of the present specification and the accompanying drawings will clarify the object, other objects, and new features of the present invention.

The following outlines a typical invention among the inventions disclosed in the present application.

A data processing device includes a host device provided with an interface which can be connected to a plurality of data lanes in differential serial communication, a first device connected to the interface via the data lanes, and a second device connected to the interface via some data lanes among the data lanes. The interface adds dummy data to actual data. Then, the interface assigns and transmits the resultant data to the data lanes. When one of the first device and the second device takes in the actual data, the other recognizes that the actual data is meaningless.

An advantage obtained by a representative of the inventions disclosed in the present application will be explained briefly as follows.

Connecting a plurality of peripherals to a host device via common lanes allows to provide a technique for enabling the data transfer corresponding to a reception capability of each of the peripherals.

### BRIEF DESCRIPTION OF THE DRAWINGS

FIG. 1 is a block diagram showing a configuration of a data processing device according to the present invention;

FIG. 2 is a block diagram showing a configuration of a processor included in the data processing device shown in FIG. 1;

FIG. 3 is an explanatory diagram showing a structure of a packet output from a MIPI-DSI;

FIG. 4 is an explanatory diagram showing a case where packets are transmitted continuously from a MIPI-DSI;

FIG. 5 is an explanatory diagram showing a relationship between transmission data and a data lane;

FIG. 6 is an explanatory diagram showing a relationship between a data lane and reception data at a main LCD and a sub-LCD;

FIG. 7 is an explanatory diagram showing a case where image data to be displayed on a main LCD is transmitted from a processor;

FIG. 8 is an explanatory diagram showing a case where image data to be displayed on a sub-LCD is transmitted from a processor;

FIG. 9 is an explanatory diagram for the generation of dummy data in a null packet to be added before an actual data packet when image data is transmitted to a main LCD;

FIG. 10 is an explanatory diagram for the generation of dummy data in a null packet to be added after an actual data packet when image data is transmitted to a main LCD;

FIG. 11 is an explanatory diagram for the generation of dummy data in a null packet to be added before an actual data packet when image data is transmitted to a sub-LCD;

FIG. 12 is an explanatory diagram for data arrangement when actual data is transmitted alternately to a main LCD and a sub-LCD;

FIG. 13 is an explanatory diagram showing data output timing when image is displayed on a main LCD and a sub-LCD at the same time;

FIG. 14 is a block diagram showing another configuration in a data processing device in accordance with the present invention;

FIG. 15 is an explanatory diagram showing a case where image data to be displayed on a main LCD is transmitted from a processor in the data processing device shown in FIG. 14; and

FIG. 16 is an explanatory diagram showing a case where image data to be displayed on a sub-LCD is transmitted from a processor in the data processing device shown in FIG. 14.

### DETAILED DESCRIPTION

1. Outline of an embodiment: First, the outline of a representative embodiment of the invention disclosed in the present application will be explained. In the outline of explanation about the representative embodiment, a reference numeral referred to by parentheses only illustrates an element included in the concept of a constituent to which the reference numeral is attached.

[1] A data processing device (1) in accordance with a representative embodiment of the present invention includes a host device (10) provided with an interface which can be connected to a plurality of data lanes in differential serial communication, a first device (12) connected to the interface via the data lanes, and a second device (13) connected to the interface via some data lanes among the data lanes. The interface adds dummy data to actual data and then assigns and transmits the resultant data to the data lanes. When one of the first device and the second device takes in the actual data, the interface causes the other one to recognize that the actual data is meaningless.

When the first device (main LCD) and the second device (sub-LCD) are connected to the host device by using the same number of the data lanes in a mobile device, the number of the data lanes needs to be determined to fit the first device which requires a higher band width than the second device. Therefore, the number of wirings for lane formation on the second device becomes larger than that in a case where the second device alone is connected to the host device. Furthermore, the second device needs to have a reception capability, which is equivalent to that of the first device, of receiving data having a band width higher than a band width required for the device. This probably increases the manufacturing cost.

In contrast to this, in the data processing device in accordance with the representative embodiment of the present invention, the first device is connected to the interface via a plurality of data lanes, and the second device is connected to the interface via some of the data lanes, and the second device is not connected to the interface via all the data lanes. Therefore, the number of wirings for the lane formation on the second device side can be minimized to obtain a band width required for the second device. Furthermore, the first device and the second device can share some of the data lanes. This can reduce the number of the data lanes.

Moreover, one of the first device and the second device takes in the actual data, the other one recognizes that the actual data is meaningless. Data transfer corresponding to reception capabilities can be performed on the first device and the second device. The second device needs no capability, which is equivalent to that of the first device, of receiving data which has a band width higher than a band width required for the second device. This does not increase the manufacturing cost. In addition, a circuit for controlling the second device needs not be mounted on the first device. As shown in Patent document 1, this is advantageous to the case of employing the configuration that a signal from the host device is received by the liquid crystal drive control device and a drive signal is supplied from the device to a circuit for the sub-display.

[2] In above [1], respective lane numbers (L0 to L3) are attached to the data lanes. Transmission data to the first device can be assigned to the data lanes sequentially in the order from the data lane having the smallest lane number (L0) and can be formed to finish at the data lane (L3) having the largest lane number.

[3] In above [2], actual data transmission to the second device can be set to start from the data lane (L0) having the smallest lane number.

[4] In above [3], the interface can be configured to output the data on the first device in order of dummy data, actual data, and dummy data.

[5] In above [4], to change the number of the data lanes easily, the interface can be provided with a register (23) which can set the number of the data lanes corresponding to the second device.

[6] In above [5], the first device can be a first liquid crystal display and the second one can be a second liquid crystal display having a lower resolution than the first liquid crystal display.

[7] In above [6], the interface can be configured to supply image data to both of the first liquid crystal display and the second liquid crystal display, in a time-division method, by outputting data in a time-division method.

[8] The semiconductor device (10) in accordance with the representative embodiment of the present invention is provided with the interface (21) which can be connected to the data lanes in differential serial communication. The interface includes a transmission circuit (22) for transmitting data via the data lanes and a transmission control circuit (24) which can control the operation of the transmission circuit. The transmission circuit adds dummy data to actual data and then assigns and transmits the resultant data to the data lanes, with the interface connected to the first device (12) via the data lanes and connected to the second device (13) via some of the data lines. When one of the first device and the second device takes in the actual data, the transmission circuit causes the other one to recognize that the actual data is meaningless.

[9] In above [8], the interface can be provided with the register (23) which can set the number of the data lanes corresponding to the second device. The transmission control circuit controls the operation of the transmission circuit in accordance with the setting information of the register.

2. Details of the embodiment: The embodiment will be described further.

### Embodiment 1

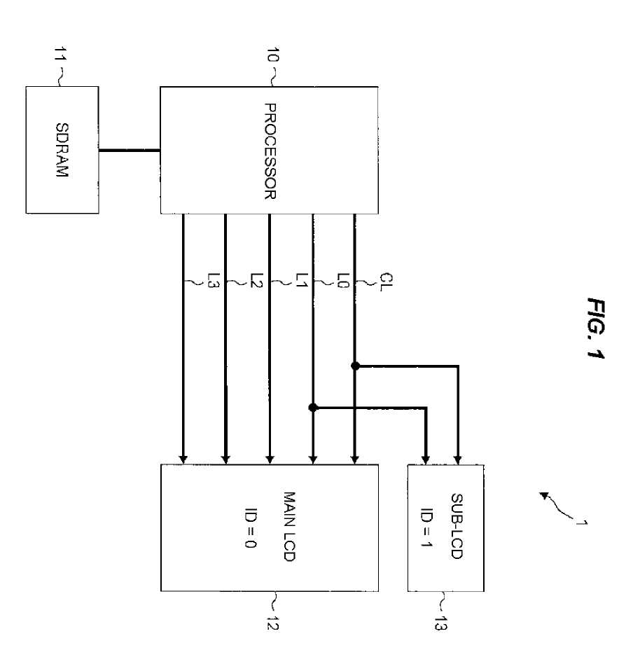

FIG. 1 shows a configuration of the data processing device in accordance with the present invention. The data processing device 1 in FIG. 1 includes a micro processor (referred to as “processor”) 10, an SDRAM (Synchronous Dynamic Random Access Memory) 11, a main LCD 12, and a sub-LCD 13. The processor 10 is mounted on a mobile device such as a mobile terminal system. The sub-LCD 13 has a lower resolution than the main LCD 12. When the main LCD 12 is provided on the front surface of a case in the mobile device, the sub-LCD 13 is provided on the rear surface of that.

The processor 10, which has no particular restriction, is formed on one semiconductor substrate such as a single-crystal silicon substrate, in accordance with a known semiconductor manufacturing technique. This processor 10 is connected to the main LCD 12 via a clock lane CL and the data lanes L0, L1, L2, and L3. The processor is connected to the sub-LCD 13 via the clock lane CL and the data lane L0. The main LCD 12 and the sub-LCD 13 share the clock lane CL and the data lane L0. The main LCD 12 has an ID set to 0 in virtual channels. The sub-LCD has an ID set to 1 in the virtual channels. The clock lane CL and each of the data lanes L0, L1, L2, and L3 are set to differential serial communication paths. A clock signal for communication is transferred via the clock lane CL. Data is transferred via the data lanes L0, L1, L2, and L3. The SDRAM 11 is connected to the processor 10 and stores image data processed and generated by the processor 10. The image data within the SDRAM 11 is read out by the processor 10. The data is displayed on the main LCD 12 and the sub-LCD 13.

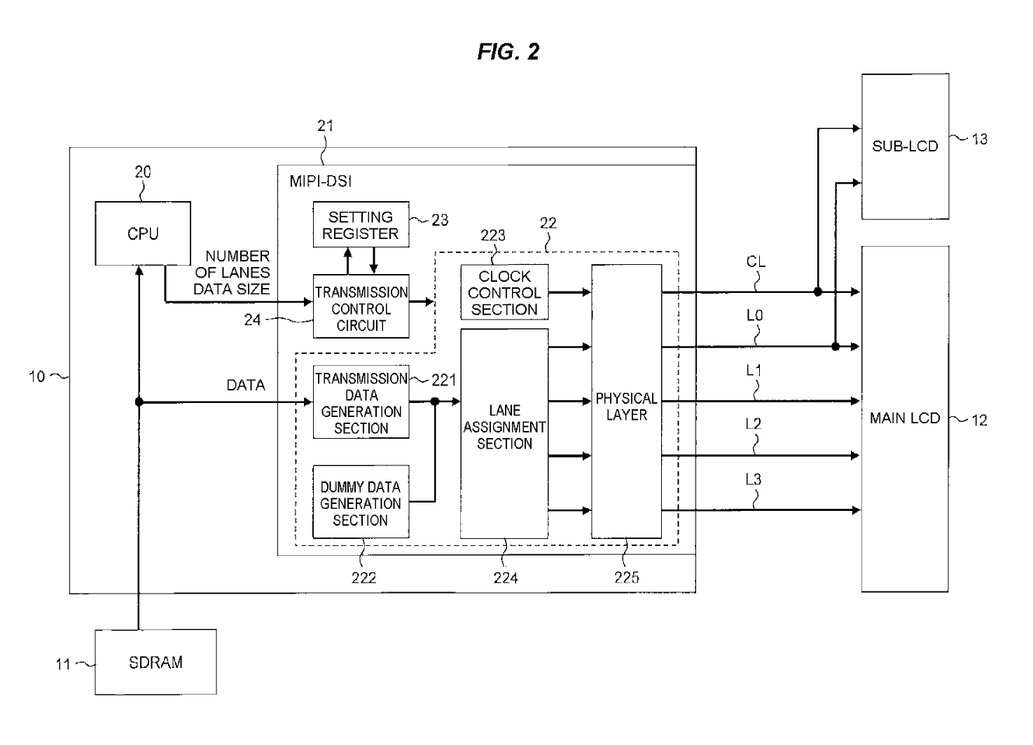

FIG. 2 shows a configuration of the processor 10.

The processor 10 includes a CPU (Central Processing Unit) 20 and an MIPI-DSI (called “interface”, “image interface”, “differential serial interface”, “differential communication control circuit”, or the like) 21. The CPU 20 controls the operation of the MIPI-DSI 21 by executing predetermined program. The MIPI-SDI 21 mediates data exchange between the SDRAM 11 and the main LCD 12 or the sub-LCD 13. The MIPI-SDI 21, which has no particular restriction, includes the transmission circuit 22, the setting register 23, and the setting register 24. The transmission circuit 22 performs the data transmission via the clock lane CL and the data lanes L0, L1, L2, and L3. The CPU 20 sets various kinds of control information such as the number of lanes and a data size in the setting register 23. The transmission control circuit 24 controls the data transmission by the transmission circuit 22 according to the setting information in the setting register 23.

The transmission circuit 22 includes a transmission data generation section 221, a dummy data generation section 222, a clock control section 223, a lane assignment section 224, and a physical layer 225. The transmission data generation section 221 forms transmission data having a predetermined structure by using the data transferred from SDRAM 11. The dummy data generation section 222 generates dummy data in a null packet to be described below. The clock control section 223 controls the frequency and the like of the clock signal transmitted via the clock lane CL. The lane assignment section 224 assigns the transmission data generated in the transmission data generation section 221 and the dummy data generated in the dummy data generation section 222 to the data lanes L0, L1, L2, and L3. This data assignment is performed in a unit of a byte and performed for the data lanes in the upward order from the data lane having the smallest lane number (L0). In the case in which the data still remains when the data has been assigned to the data lane having the largest lane number (L3), the data is assigned again to the data lanes in the upward order from the data lane having the smallest lane number (L0). Data length of the packet is adjusted so that this data assignment is completed at the data lane having the largest lane number (L3). The clock signal controlled in the clock control section 223 and the transmission data assigned in the lane assignment section 224 are output to the corresponding lanes via the physical layer 225. The physical layer 225 adjusts voltage level in a differential signal output to each of the clock lane CL and the data lanes L0, L1, L2, and L3.

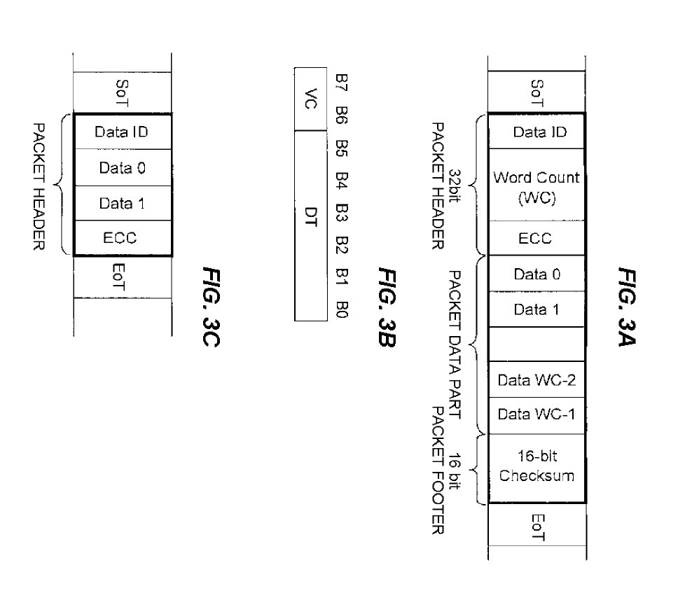

FIG. 3 shows a packet structure output from the MIPI-DSI 21.

The packets include a long packet and a short packet.

As shown in FIG. 3A, the long packet includes a packet header, a packet data part, and a packet footer. The packet header consists of four bytes and includes “Data ID”, “Word Count”, and “ECC”. “Data ID” consists of one byte and includes a virtual channel identifier (VC) and a data type (DT) as shown in FIG. 3B. “Word Count” consists of two bytes and indicates the number of words in the packet data part. “ECC” is an error correction code consisting of one byte. The packet data part is a payload specific to an application. Its size is indicated by “Word Count”. The packet footer is a checksum which is an error detecting code. The checksum is a CRC consisting of two bytes.

As shown in FIG. 3C, the short packet includes a packet header consisting of four bytes. This packet header includes “Data ID”, “Data 0”, “Data 1”, and “ECC” each of which consists of one byte. “Data. ID” consists of one byte and includes a virtual channel identifier (VC) and a data type (DT) as shown in FIG. 3B. “Data 0” and “Data 1” are a data part consisting of two bytes. “ECC” is, an error correcting code consisting of one byte.

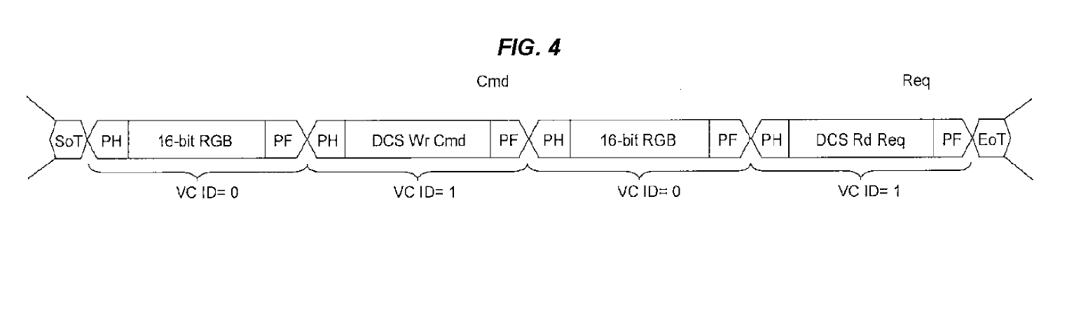

FIG. 4 shows continuous packet transmission. Data sets (“16-Bit RGB”, “DCS Wr Cmd”, and “DCS Rd Req”) can be transmitted continuously to different transfer addresses by using the virtual channel IDs (VC ID=0, and VC ID=1). “PH” indicates the packet header. “PF” indicates the packet footer.

In the MIPI-DSI, HS (High Speed) transfer and LP (Low Power) transfer are available as a data transfer method. The HS transfer uses all the data lanes. The LP transfer uses only one of the data lanes. The data transfer from the processor to a peripheral (forward data transfer) uses the HS transfer or the LP transfer. The data transfer from the peripheral to the processor (reverse data transfer) uses the LP transfer. In the HS transfer, the amplitude of an output signal is smaller than that in the LP transfer. For example, the signal amplitude in the HS transfer is set to 100 to 300 mV and the signal amplitude in the LP transfer is set to 0 to 1.2 V.

Basic data transmission by the MIPI-DSI will be explained.

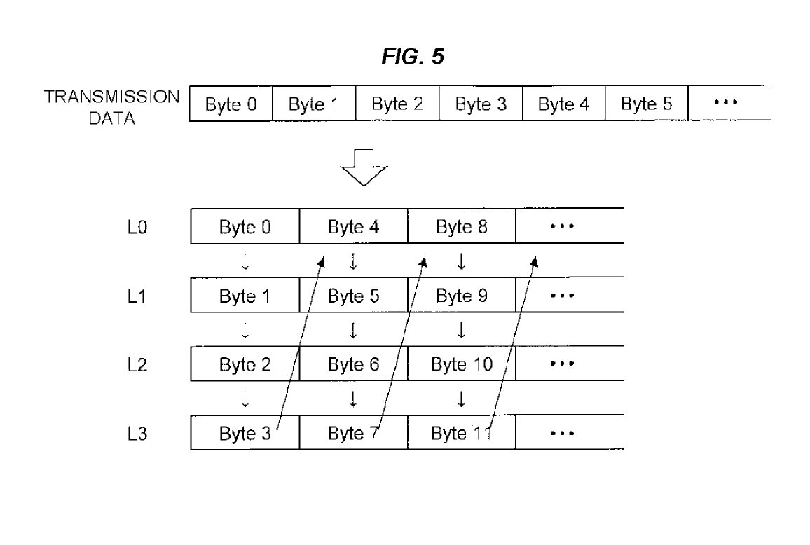

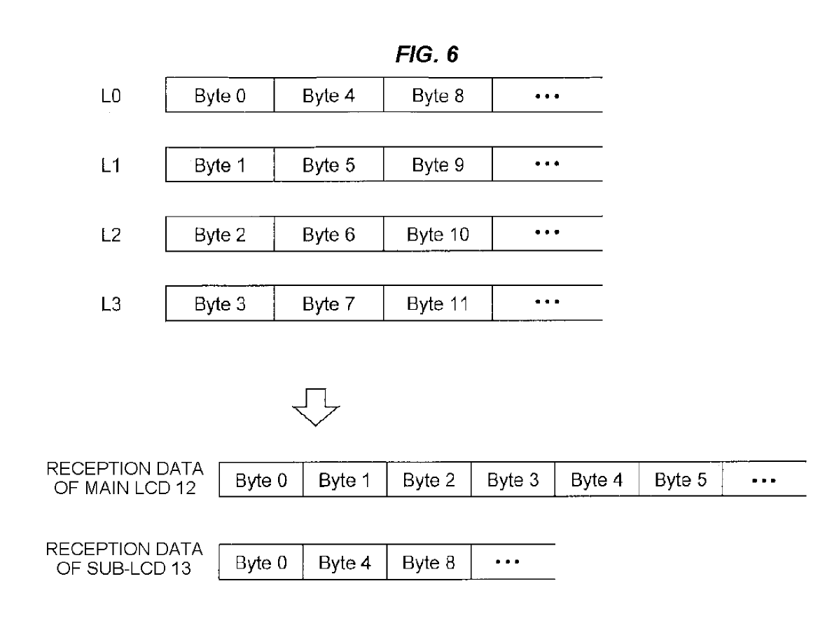

As shown in FIG. 5, when the transmission data is Byte 0, Byte 1, Byte 2, Byte 3, Byte, 4, Byte 5, and the like, this transmission data is output to be assigned to the data lanes L0, L1, L2, and L3 in the HS transfer. Then, the data is transferred to the peripheral. The data assignment is performed for the data lanes in the upward order from the data lane having the smallest lane number (L0). In a case where the data still remains when the data has been assigned to the data lane having the largest lane number (L3), the data is assigned again to the data lanes in the upward order from the data lane having the smallest lane number (L0). When such data transmission is performed, as shown in FIG. 6, the main LCD 12 can receive the data correctly in order of Byte 0, Byte 1, Byte 2, Byte 3, Byte 4, and Byte 5. In contrast to this, the sub-LCD 13 basically can receive no data except the data transferred via the data lane L0, and thus its reception data is different from the reception data at the main LCD 12 in order of Byte 0, Byte 4, Byte 8, and the like.

When the data is transmitted to be assigned to the data lanes, the difference between the reception data received by the main LCD 12 and the data received by the sub-LCD 13 is utilized, and, when the actual data is taken in one of the main LCD 12 and the sub-LCD 13, the other one recognizes that the actual data is meaningless. Thus, the image data can be transferred correctly to the main LCD 12 or the sub-LCD 13 as follows.

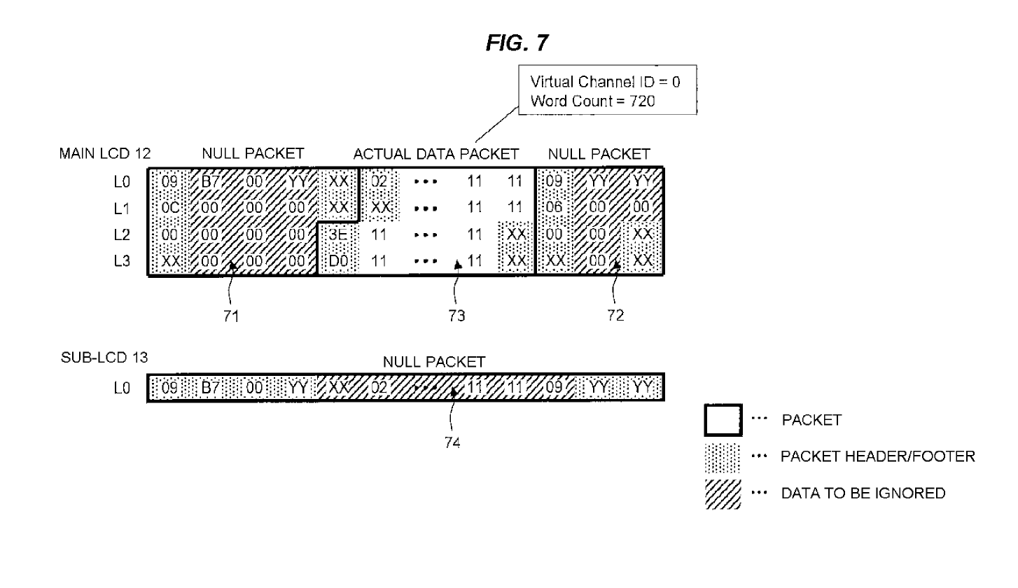

FIG. 7 shows a case where the processor 10 transmits the image data to be displayed on the main LCD (ID=0) 12 in the data processing device 1 in FIG. 1.

The transmission data generation section 221 within the processor 10 forms an actual data packet and the dummy data generation section 222 within the processor forms a null packet. A data type (DT) of the null packet is set to “09” and the null packet is a packet which includes no effective data. The actual data packet and the null packet are assigned to the data lanes L0, L1, L2, and L3 by the lane assignment section 224. When viewed from the main LCD 12, the null packets are arranged before and after the actual data packet which is transferred via the data lanes L0, L1, L2, and L3. A data type (DT) of the actual data packet is set to “3E”. The size of a packet data part 73 is indicated by “Word Count”. “Word Count” is set to “D0, 02” (720). “XX” is set to a value calculated by the ECC or the CRC.

The size of a packet data part in the null packet which is arranged before the actual data packet is indicated by “Word Count”. “Word Count” is set to “0C, 00”. The packet data part 71 provided with hatching embeds dummy data. This dummy data is ignored in the main LCD 12. “XX” is set to a value calculated by the ECC or the CRC.

“Word Count” of the null packet arranged after the actual data packet is set to “06, 00”. A packet data part 72 provided with hatching embeds dummy data. This dummy data is ignored in the main LCD 12. “XX” is set to a value calculated by the ECC or the CRC.

The main LCD 12 displays image in accordance with the packet data part 73 in the actual data packet transferred to the main LCD 12 via the data lanes L0, L1, L2, and L3.

Furthermore, among the data sets transferred to the main LCD 12 via the data lanes L0, L1, L2, and L3, the data of the data lane L0 is transferred also to the sub-LCD 13. A data type (DT) of the packet transferred to the sub-LCD 13 via the data lane L0 is set to “09”. The packet is regarded as a packet without including effective data. “Word Count” is set to “B7, 00”. A packet data part 74 provided with hatching is ignored in the sub-LCD 13. “YY” is set to a value calculated by the ECC or the CRC.

In this manner, when the processor 10 transmits the image data to be displayed on the main LCD (ID=0) 12, among the data sets transferred to the main LCD 12 via the data lanes L0, L1, L2, and L3, the data of the data lane L0 is transferred also to the sub-LCD 13. The data via the data lane L0 is the null packet. This data is ignored in the sub-LCD 13 at this time. Thus, no image is displayed with the data lane L0 in accordance with the data in the data lane L0.

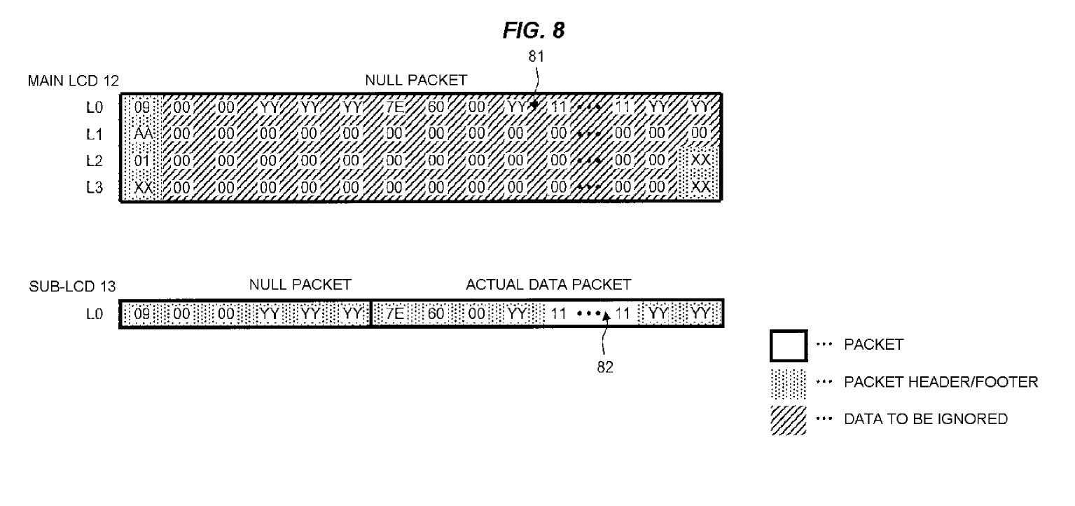

FIG. 8 shows a case where the processor 10 transmits the image data to be displayed on the sub-LCD (ID=1) 13 in the data processing device 1 in FIG. 1.

When viewed from the sub-LCD 13, a null packet is arranged before an actual data packet transmitted via the data lane L0. A data type (DT) of the actual data packet is set to “7E”. The size of a packet data part 82 is indicated by “Word Count”. “Word Count” is set to “60, 00” (96). “YY” is set to a value calculated by the ECC or the CRC. The size of a packet data part in the null packet arranged before the actual data packet is indicated by “Word Count”. “Word Count” is set to “00, 00”. No data packet part exists. The sub-LCD 13 displays image in accordance with the packet data part 82 in the actual data packet.

When data is transmitted to the sub-LCD 13 via the data lane L0, a null packet is transferred to the main LCD 12 via the data lanes L0, L1, L2, and L3. When viewed from the main LCD 12, the data transferred via each of the data lanes L0, L1, L2, and L3 is the null packet with a data type (DT) set to “09”. The size of this null packet is indicated by “AA, 01” of “Word Count” and a packet data part 81 provided with hatching embeds dummy data. This dummy data is ignored in the main LCD 12. “XX” is set to a value calculated by the ECC or the CRC.

Next, dummy data generation in the dummy data generation section 222 will be explained.

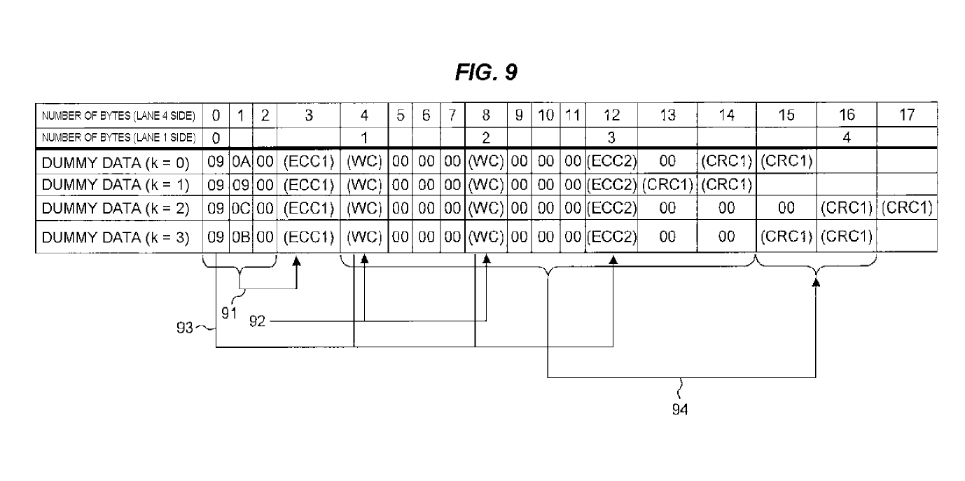

FIG. 9 shows a dummy data generation in the null packet added before an actual data packet when the image data is transmitted to the main LCD 12. A data transmission address by the data lines L0, L1, L2, and L3 is set as Lane 4 and a data transmission address by the data lane L0 is set as Lane 1.

When “n” is set as the number of bytes of the actual data packet (including the packet header and the packet footer), “k” is obtained from the following formula. The number in the parentheses is rounded off after the decimal point. Because of this, “k” indicates a remainder when the number of bytes in the actual data “n” is divided by four (number of lanes).

k=n−(n/4)×4 [Formula 1]

Then, ECC 1 is calculated from the packet header to be transmitted to Lane 4 and “WC”, a value of “Word Count”, is calculated by the following formula. “Word Count” consisting of two bytes is arranged in order of lower eight bits and higher eight bits.

WC=(n+6)/4 [Formula 2]

Next, ECC 2 is calculated from the packet header to be transmitted to Lane 1 and CRC 1 for the checksum is calculated from the packet data to be transmitted to Lane 4.

In this manner, the null packet (dummy data) to be added before the actual data packet is generated when the image data is transmitted to the main LCD 12. The dummy data differs depending on the value of “k” of Formula 1. An appropriate dummy data length is determined in accordance with the value of “k” which is a remainder when the number of bytes of the actual data “n” is divided by four (number of lanes). Because of this, the transmission of the actual data packet can be finished at the data lane having the largest lane number (L3) as shown in FIG. 7. As a result, the assigning of the transmission data in the lane assignment section 224 can be finished easily at the data lane having the largest lane number (L3).

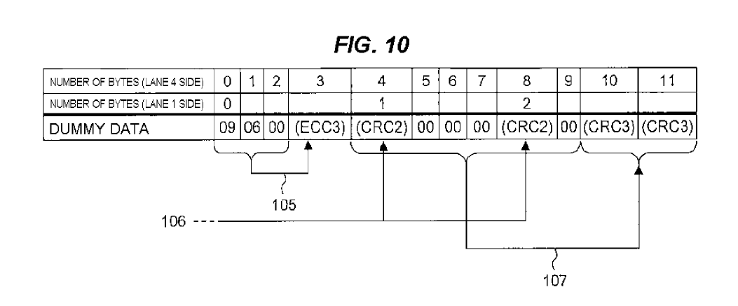

FIG. 10 shows a dummy data generation in the null packet added after the actual data packet when the image data is transmitted to the main LCD 12.

First, ECC 3 is calculated from the packet header to be transmitted to the lane 4. Then, CRC 2 is calculated from packet data to be transmitted to Lane 1 and CRC 3 for the checksum is calculated from the packet data to be transmitted to Lane 4.

In this manner, the dummy data is generated in the null packet added after the actual data packet when the image data is transmitted to the main LCD 12.

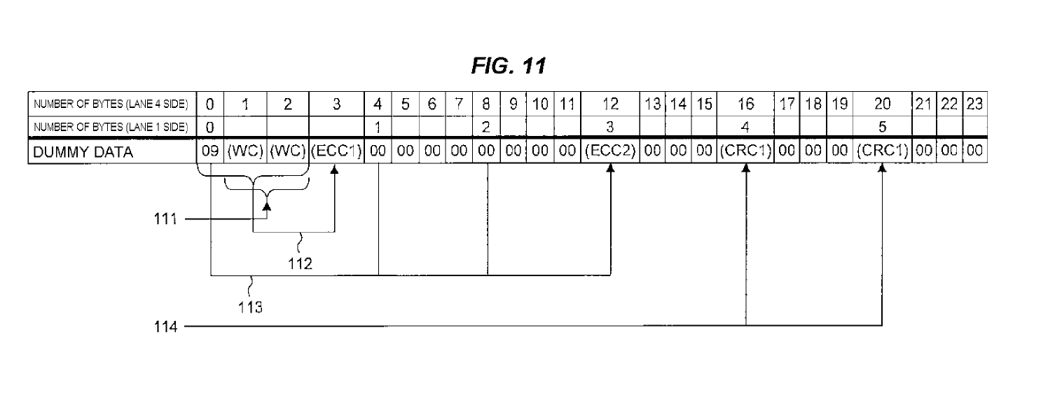

FIG. 11 shows a dummy data generation in the null packet added before an actual data packet when the image data is transmitted to the sub-LCD 13.

When “n” is set as the number of bytes of an actual data packet (including the packet header and the packet footer), “WC”, a value of “Word Count”, is calculated by the following formula. “Word Count” consisting of two bytes is arranged in order of lower eight bits and higher eight bits.

WC=n×4+18 [Formula 3]

Next, ECC 1 is calculated from the packet header to be transmitted to Lane 4 and ECC 2 is calculated from the packet header to be transmitted to Lane 1. Then, CRC 1 for the checksum is calculated. At this time, CRC 1 is set as “FFFFh”.

Dummy data is added after the actual data packet when the image data is transmitted to the sub-LCD 13. For this dummy data, the CRC which is calculated from the packet data to be transmitted to Lane 4 is transmitted as a packet header via the data lanes L2 and L3 when the last byte of the actual data is transmitted via the lane L0.

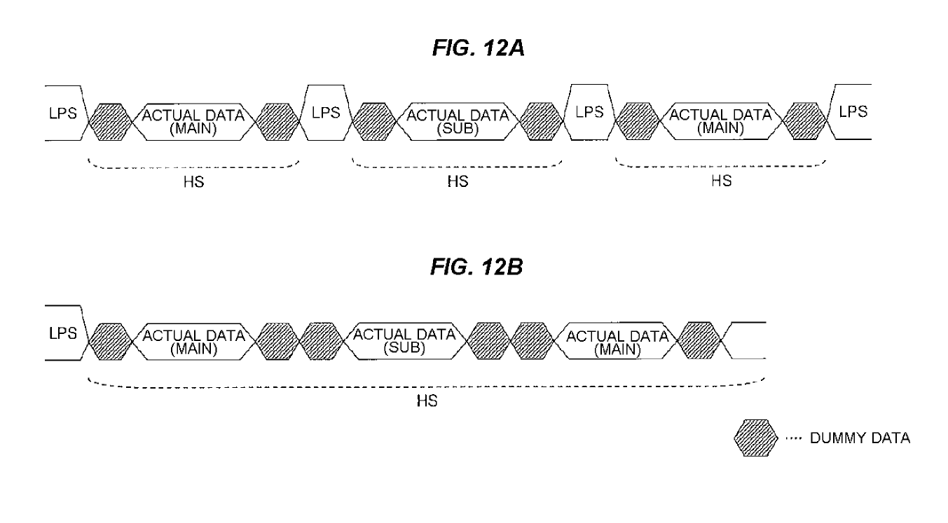

FIG. 12 shows data arrangements when the actual data sets are transmitted alternately to the main LCD 12 and the sub-LCD 13.

When the data transfer method is switched to the LP transfer mode every time the HS (High Speed) transfer is performed, LPS (Low Power State) is provided for every HS transfer as shown in FIG. 12A. LPS indicates a state in which the HS transfer mode is switched to the LP transfer mode and the data output is stopped. In the HS transfer mode in which the processor transfers the display image data to the main LCD 12, the actual data to be used for display on the main LCD 12 and the dummy data sets added before and after the actual data are transmitted. In the HS transfer mode in which the processor transmits the display image data to the sub-LCD 13, the actual data to be used for display on the sub-LCD 13 and the dummy data sets added before and after the actual data are transmitted.

When the data is transmitted continuously to the main LCD 12 and the sub-LCD 13 in the HS transfer mode, LPS can be omitted as shown in FIG. 12B. In this case, no overhead due to mode switching occurs.

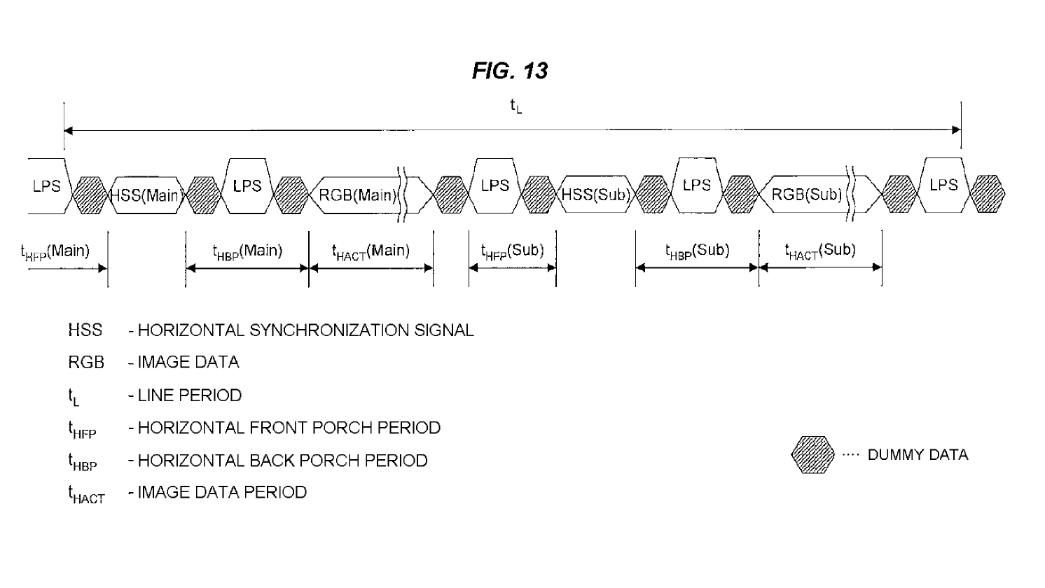

FIG. 13 shows data output timing when image is displayed on the main LCD 12 and the sub-LCD 13 at the same time.

“HSS (Main)” is a horizontal synchronization signal of the main LCD 12, “HSS (Sub)” is a horizontal synchronization signal of the sub-LCD 13. “RGB (Main)” is image data to be displayed on the main LCD 12. “RGB (Sub)” is image data to be displayed on the sub-LCD 13. “t_{L},” is a line time. “t_{HFP} (Main)” is a horizontal front porch period of the main LCD 12. “t_{HFP} (Sub)” is a horizontal front porch period of the sub-LCD 13. “tₗₐₚ (Main)” is a horizontal back porch period of the main LCD 12. “t_{HBP} (Sub)” is a horizontal back porch period of the sub-LCD 13. “t_{HACT} (Main)” is an image data period of the main LCD 12. “t_{HACT} (Sub)” is an image data period of the sub-LCD 13.

When the main LCD 12 and the sub-LCD 13 display image at the same time, the horizontal synchronization signal HSS (Main) of the main LCD 12, the image data RGB (Main) to be displayed on the main LCD 12, the horizontal synchronization signal HSS (Sub) of the sub-LCD 13, and the image data RGB (Sub) to be displayed on the sub-LCD 13 are transmitted in the line time t_{L}, in this order.

The dummy data is arranged before and after the horizontal synchronization signal HSS (Main) of the main LCD 12, the image data RGB (Main) to be displayed on the main LCD 12, the horizontal synchronization signal HSS (Sub) of the sub-LCD 13, and the image data RGB (Sub) to be displayed on the sub-LCD 13. Furthermore, LPS is provided between the image data RGB (Main) to be displayed on the main LCD 12, the horizontal synchronization signal HSS (Sub) of the sub-LCD 13, and the image data RGB (Sub) to be displayed on the sub-LCD 13. The image data RGB (Main) to be displayed on the main LCD 12 is transferred in the image data period t_{HACT} (Main) of the main LCD 12. The image data RGB (Sub) to be displayed on the sub-LCD 13 is transferred in the image data period t_{HACT} (Sub) of the sub-LCD 13. LPS is assigned to the horizontal front porch periods t_{HFP} (Main) and t_{HFP} (Sub) and the horizontal back porch periods t_{HBT} (Main) and t_{HBP} (Sub).

### Embodiment 2

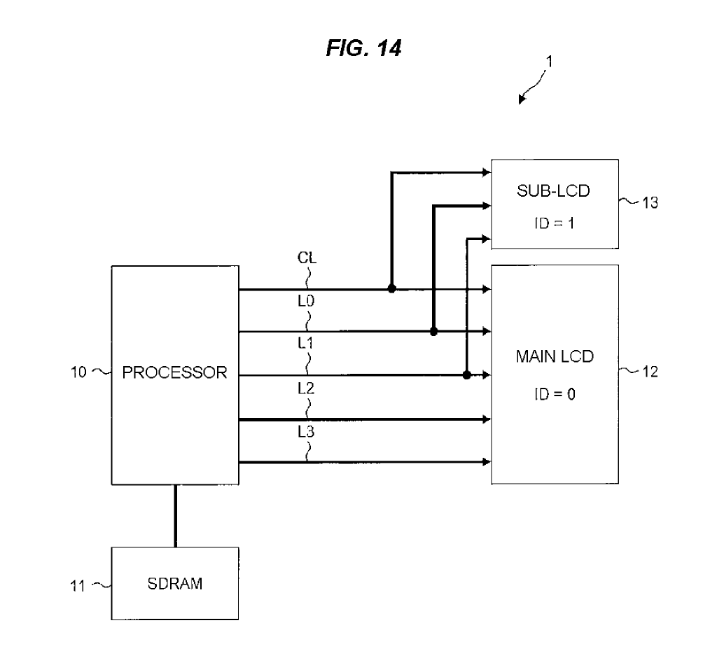

FIG. 14 shows another configuration of the data processing device in accordance with the present invention.

The data processing device sin FIG. 14 significantly differs from that in FIG. 1 in that the data is transferred to the sub-LCD 13 via the data lanes L0 and L1.

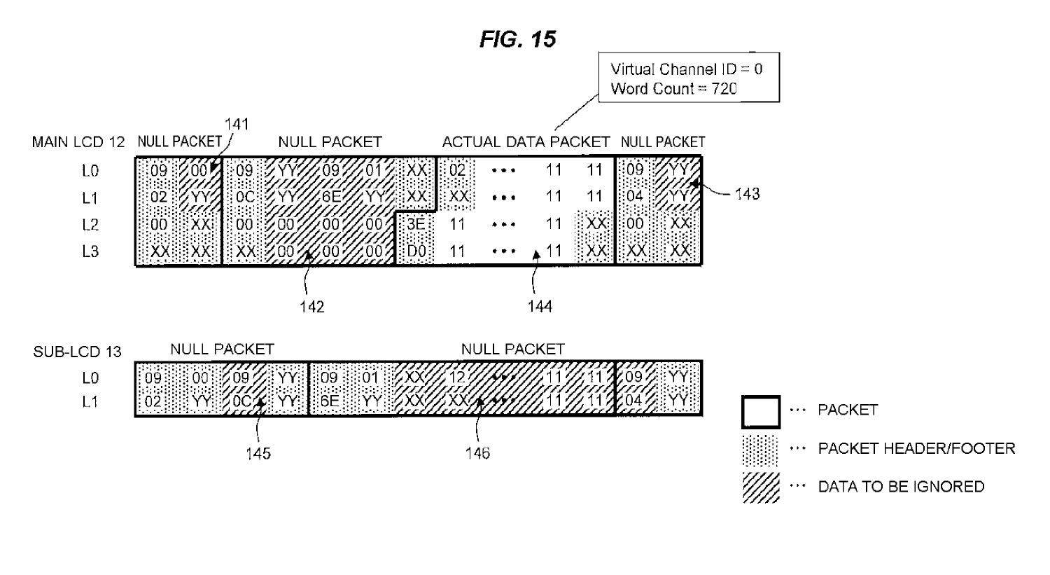

FIG. 15 shows transmission of the image data to be displayed on the main LCD (ID=0) 12 from the processor 10 in the data processing device 1 in FIG. 14. In FIG. 15, two null packets are transmitted before an actual data packet.

Each data type (DT) of the two null packets are set as “09”. The two null packets are set as packets without including effective data. The actual data packets and the null packets are assigned to the data lanes L0, L1, L2, and L3 by the lane assignment section 224. The data type (DT) of the actual data packet is set as “3E”. The size of a packet data part 144 is indicated by “Word Count”. “Word Count” is set to “D0, 02” (720). “XX” is set as a value calculated by the ECC or the CRC.

The size of a packet data part in each of the two null packets arranged before the actual data packet is indicated by “Word Count”. “Word Count” of the first null packet is set as “02, 00” and dummy data in a packet data part 141 provided with hatching is ignored in the main LCD 12. Similarly, “Word Count” of the second null packet is set as “0C, 00” and dummy data in a packet data part 142 provided with hatching is ignored in the main LCD 12. “XX” is set as a value calculated by the ECC or the CRC.

A null packet arranged after the actual data packet has “Word Count” being set as “04, 00” and dummy data provided with hatching in a packet data part 143 is ignored in the main LCD 12. “XX” is set as a value calculated by the ECC or the CRC.

The main LCD 12 displays image in accordance with the packet data part 144 in the actual data packet transferred to the main LCD 12 via the data lanes L0, L1, L2, and L3.

Furthermore, the data sets of the data lane L0 and L1 among the data sets transferred to the main LCD 12 via the data lanes L0, L1, L2, and L3 are transferred also to the sub-LCD 13. The packets transferred to the sub-LCD 13 via the data lane L0 are set as two null packets, whose data types (DTs) are set as “09”. “Word Count” of the first null packet is set as “02, 00”. A packet data part 145 provided with hatching is ignored in the sub-LCD 13. Similarly, “Word Count” of the second null packet is set as “6E, 01” and a packet data part 146 provided with hatching is ignored in the sub-LCD 13. “YY” is set as a value calculated by the ECC or the CRC.

In this manner, when the processor 10 transmits the image data to be displayed on the main LCD (ID=0) 12, the data sets via the data lanes L0 and L1 among the data sets transferred to the main LCD 12 via the data lanes L0, L1, L2, and L3 are transferred also to the sub-LCD 13. At this time, data sets of the data lanes L0 and L1, each of which is the null packet, are ignored in the sub-LCD 13. Thus, no image is displayed in accordance with the data sets of the data lanes L0 and L1.

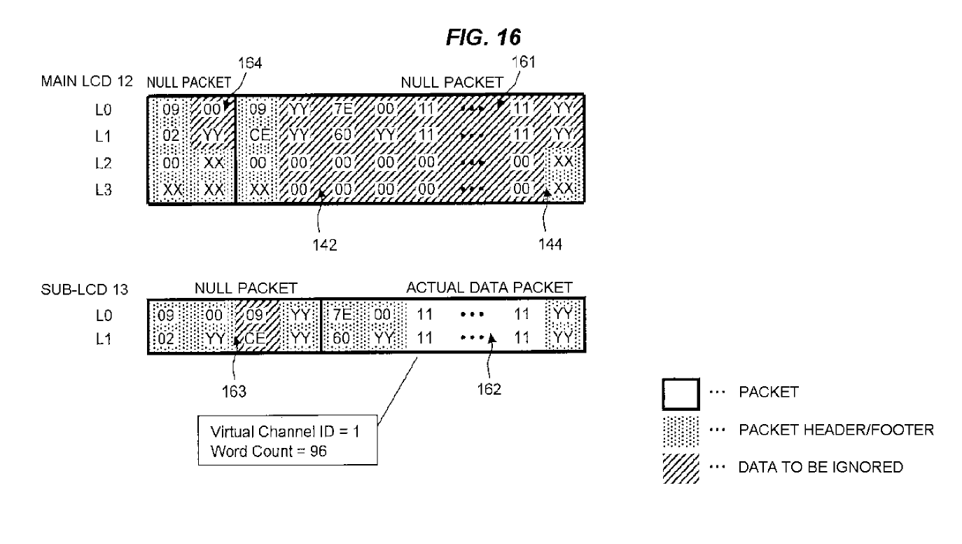

FIG. 16 shows a case of transmitting the image data displayed on the sub-LCD (ID=1) 13 from the processor 10 in the data processing device 1 in FIG. 14.

When viewed from the sub-LCD 13, a null packet is arranged before an actual data packet transferred via each of the data lanes L0 and L1. The data type (DT) of the actual data packet is set as “7E”. The size of a packet data part 162 is indicated by “Word Count”. “Word Count” is set as “60, 00” (96). “YY” is set as a value calculated by the ECC or the CRC. The size of a packet data part in the null packet arranged before the actual data packet is indicated by “Word Count”. “Word Count” is set as “02, 00”. A packet data part 163 provided with hatching is ignored in the sub-LCD 13. The sub-LCD 13 displays image in accordance with the packet data part 162 in the actual data packet.

When data is transmitted to the sub-LCD 13 via the data lanes L0 and L1, two null packets are transferred to the main LCD 12 via the data lanes L0, L1, L2, and L3. When viewed from the main LCD 12, the data transferred via the data lanes L0, L1, L2, and L3 is set as two null packets, whose data types (DTs) are set as “09”. The size of the first null packet is indicated by “02, 00” of “Word Count”. A packet data part 164 provided with hatching embeds dummy data. This dummy data is ignored in the main LCD 12. Similarly, the size of the second null packet is indicated by “CE, 00” of “Word Count”, and a packet data part 161 provided with hatching embeds dummy data and this dummy data is ignored in the main LCD 12. “XX” is set as a value calculated by the ECC or CRC.

The invention achieved by the present inventors has been explained specifically in accordance with the embodiments. Obviously the present invention is not limited to the embodiments and can be modified in a range without departing from the purport of the invention.

The number of the data lanes which connects the processor 10, the main LCD 12 and the sub-LCD 13 can be set.

Other peripherals can be used in place of the main LCD 12 and the sub-LCD 13.

What is claimed is:

1. A data processing device, comprising:
a host device provided with an interface which can be connected to a plurality of data lanes in differential serial communication;
a first device connected to the interface via the data lanes; and
a second device connected to the interface via some of the above data lanes, wherein
the interface adds dummy data to actual data and then assigns and transmits the resultant data to the data lanes, and
when the actual data is taken in one of the first device and the second device, the interface causes the other one to recognize that the actual data is meaningless.

2. The data processing device according to claim 1,
wherein transmission data to the first device is assigned sequentially to the data lanes from the data lane having the smallest lane number and is formed to finish at the data lane having the largest lane number.

3. The data processing device according to claim 2,
wherein actual data transmission to the second device starts from the data lane having the smallest lane number.

4. The data processing device according to claim 3,
wherein the interface performs data output on the first device in order of the dummy data, the actual data, and the dummy data.

5. The data processing device according to claim 4,
wherein the interface includes a register which can set the number of data lanes corresponding to the second device.

6. The data processing device according to claim 5,
wherein the first device is a first liquid crystal display, and the second device is a second liquid crystal display having a resolution lower than the first liquid crystal display.

7. The data processing device according to claim 6,
wherein the interface supplies image data sets for display to both of the first liquid crystal display and the second liquid crystal display in a time-division method by outputting data in the same method.

8. A semiconductor device provided with an interface which can be connected to a plurality of data lanes in differential serial communication, the interface comprising:
a transmission circuit for transmitting data via the data lanes; and
a transmission control circuit which can control operation of the transmission circuit, wherein
the transmission circuit adds dummy data to actual data and then assigns and transmits the resultant data to the data lanes, in a state in which the transmission circuit is connected to a first device via the data lanes and also connected to a second device via some data lanes among the data lanes, and,
when the actual data is taken in one of the first device and the second device, the transmission circuit causes the other one to recognize that the actual data is meaningless.

9. The semiconductor device according to claim 8, wherein
the interface includes a register which can set the number of data lanes corresponding to the second device, and
the transmission control circuit controls operation of the transmission circuit in accordance with setting information of the register.
